(19) United States
(12) Patent Application Publication
(10) Pub. No.: US 2010/0108096 A1
(43) Pub. Date: May 6, 2010

(54) Liquid processing method and apparatus

(75) Inventors: Teruomi Minami, Koshi-shi (JP); Takashi Yabuta, Tosu-shi (JP); Kazuki Kosai, Tosu-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: TOKYO ELECTRON LIMITED, Tokyo (JP)

(21) Appl. No.: 12/320,536

(22) Filed: Jan. 28, 2009

(30) Foreign Application Priority Data
Nov. 5, 2008 (JP) 2008-284533

(51) Int. Cl. B08B 3/10; B08B 3/08; B08B 13/00

(52) U.S. Cl. 134/10; 134/104.2

(57) ABSTRACT

A liquid processing method performs a liquid process after an etching target film formed on a surface of a substrate is etched through a hard mask layer used as an etching mask and having a predetermined pattern formed therein. The liquid process is used for removing the hard mask layer and a polymer deposited due to etching. The method includes a second step of switching from a discard side to a collection side for collecting a chemical liquid used in the liquid process and recycling the chemical liquid in the liquid process, when the hard mask layer is removed by a first step to a residual quantity at which the chemical liquid used in the liquid process becomes collectable for reuse.

### BACKGROUND OF THE INVENTION

1. Field of the Invention

The present invention relates to a liquid processing method, liquid processing apparatus, and storage medium, which are used for performing a liquid process to remove a hard mask layer used for e.g., etching an organic low dielectric constant film (Low-k film).

2. Description of the Related Art

In recent years, due to demands for improvements in the operation speeds of semiconductor devices and the miniaturization and integration levels of interconnection patterns, it has been required to decrease the capacitance between interconnection lines, to increase the conductivity of interconnection lines, and to improve the electro-migration resistance of interconnection lines. As a technique to address these issues, a Cu multi-layer interconnection line technique has attracted attention, in which copper (Cu) is used as an interconnection line material and a low dielectric constant film (Low-k film) is used as an inter-level insulating film. Copper (Cu) is higher in conductivity and electro-migration resistance than aluminum (Al) and tungsten (W).

A Cu multi-layer interconnection line technique may adopt a dual damascene method that comprises a step of forming a groove and hole for an interconnection line in a Low-k film and a step of embedding Cu in the groove and hole. An organic Low-k film is often used for this purpose, and an inorganic hard mask (HM) formed of, e.g., a Ti film or TiN film, is used as a mask for etching the organic Low-k film, because a photo-resist film, which is also an organic film, cannot provide a sufficient etching selectivity relative to the organic Low-k film. In this process, the HM is first etched in accordance with a predetermined pattern by use of a photo-resist mask, and then the Low-k film is etched by use of the HM thus patterned as a mask.

After the etching, it is necessary to remove the residual part of the HM. This HM removal may be performed in a single-substrate cleaning apparatus by use of a chemical liquid dedicated to the HM removal. In general, a cleaning process of this kind is performed by continuously supplying a chemical liquid onto the center of a semiconductor wafer or target substrate, while rotating the semiconductor wafer, so that the chemical liquid is spread by a centrifugal force all over the front surface of the semiconductor wafer W (for example, Jpn. Pat. Appln. KOKAI Publication No. 2004-146594).

Incidentally, since chemical liquids for HM removal of this kind are expensive, attempts have been made to collect a chemical liquid in a tank to reuse it after the liquid is delivered onto a semiconductor wafer and used for a cleaning process. However, the chemical liquid used in the cleaning process contains components of the HM and/or device. Where the amount of such components becomes large, components of the chemical liquid are decomposed and make it difficult to reuse the chemical liquid in practice. Accordingly, in the present circumstances, chemical liquids for HM removal cannot be reused but discarded, resulting in a large cost.

### BRIEF SUMMARY OF THE INVENTION

An object of the present invention is to provide a liquid processing method that allows a chemical liquid to be collected and reused after the chemical liquid is used for removing a hard mask, and a liquid processing apparatus for performing the liquid processing method. An additional object of the present invention is to provide a computer readable storage medium that stores a program for executing the liquid processing method.

According to a first aspect of the present invention, there is provided a liquid processing method for performing a liquid process, after an etching target film formed on a surface of a substrate is etched through a hard mask layer used as an etching mask and having a predetermined pattern formed therein, the liquid process being used for removing the hard mask layer and a polymer deposited due to etching, the method comprising: a first step of performing removal of the hard mask layer by supplying a chemical liquid onto the substrate while rotating the substrate, while discarding the chemical liquid used in the liquid process by use of a discard side; a second step of switching from the discard side to a collection side for collecting the chemical liquid used in the liquid process and recycling the chemical liquid in the liquid process, when the hard mask layer is removed by the first step to a residual quantity at which the chemical liquid used in the liquid process becomes collectable for reuse; and a third step of then performing removal of a residual part of the hard mask layer and the polymer, or the polymer, by supplying the chemical liquid onto the substrate while rotating the substrate, while collecting and reusing the chemical liquid used in the liquid process by use of the collection side.

In the first aspect, the first step may comprise intermittently supplying the chemical liquid onto the substrate while rotating the substrate, but keeping the surface of the substrate wet with the chemical liquid during chemical liquid stop periods of not supplying the chemical liquid between chemical liquid supply periods of supplying the chemical liquid, and the third step may comprise continuously supplying the chemical liquid onto the substrate while rotating the substrate. In this case, the first step may comprise first supplying the chemical liquid to form a liquid film on the substrate, and then alternately repeating the chemical liquid stop periods and the chemical liquid supply periods. The first step may be arranged such that each of the chemical liquid stop periods falls within a range of 10 to 30 seconds and each of the chemical liquid supply periods falls within a range of 1 to 5 seconds. The first step may be arranged to rotate the substrate at a rotational speed of 50 to 300 rpm.

In the first aspect, each of the first step and the third step may comprises continuously supplying the chemical liquid onto the substrate while rotating the substrate, such that a chemical liquid supply flow rate used in the first step is set smaller than a chemical liquid supply flow rate used in the third step.

In the first aspect, the second step may be arranged to switch from the discard side to the collection side at a timing when or after elapse of a time period obtained in advance for the hard mask layer to be removed by a predetermined ratio within a range of 60 to 100%.

According to a second aspect of the present invention, there is provided a liquid processing apparatus for performing a liquid process, after an etching target film formed on a surface of a substrate is etched through a hard mask layer used as an etching mask and having a predetermined pattern formed therein, the liquid process being used for removing the hard mask layer and a polymer deposited due to etching, the apparatus comprising: a holding mechanism configured to rotate along with the substrate held thereon; a rotation mechanism configured to rotate the holding mechanism; a chemical liquid supply mechanism configured to supply a chemical liquid onto the surface of the substrate held on the holding mechanism; a drain cup configured to surround an edge of the substrate held on the holding mechanism and to receive the chemical liquid used in the liquid process and thrown off from the substrate; a drain line configured to discharge the chemical liquid used in the liquid process and received by the drain cup; a collecting mechanism configured to collect for reuse the chemical liquid used in the liquid process and discharged from the drain cup; a switching mechanism configured to switch between a discard side for discarding the chemical liquid used in the liquid process through the drain line and a collection side for collecting the chemical liquid used in the liquid process by the collecting mechanism; and a control section configured to control the rotation mechanism, the chemical liquid supply mechanism, and the switching mechanism, wherein the control section is preset to execute a first step of performing removal of the hard mask layer by supplying the chemical liquid from the chemical liquid supply mechanism onto the substrate while rotating the substrate by the rotation mechanism, while discarding the chemical liquid used in the liquid process by use of the discard side set by the switching mechanism, a second step of switching from the discard side to the collection side by the switching mechanism when the hard mask layer is removed by the first step to a residual quantity at which the chemical liquid used in the liquid process becomes collectable for reuse; and a third step of then performing removal of a residual part of the hard mask layer and the polymer, or the polymer, by supplying the chemical liquid from the chemical liquid supply mechanism onto the substrate while rotating the substrate by the rotation mechanism, while collecting and reusing the chemical liquid used in the liquid process by use of the collection side set by the switching mechanism.

In the second aspect, the control section may be preset to execute the first step to comprise intermittently supplying the chemical liquid from the chemical liquid supply mechanism onto the substrate while rotating the substrate by the rotation mechanism, but keeping the surface of the substrate wet with the chemical liquid during chemical liquid stop periods of not supplying the chemical liquid between chemical liquid supply periods of supplying the chemical liquid, and the third step to comprise continuously supplying the chemical liquid onto the substrate while rotating the substrate by the rotation mechanism. In this case, the control section is preferably preset to execute the first step to comprise first supplying the chemical liquid to form a liquid film on the substrate, and then alternately repeating the chemical liquid stop periods and the chemical liquid supply periods.

In the second aspect, the control section may be preset to execute each of the first step and the third step to comprise continuously supplying the chemical liquid onto the substrate while rotating the substrate, such that a chemical liquid supply flow rate used in the first step is set smaller than a chemical liquid supply flow rate used in the third step.

In the second aspect, the control section may be preset to execute the second step to switch from the discard side to the collection side by the switching mechanism at a timing when or after elapse of a time period obtained in advance for the hard mask layer to be removed by a predetermined ratio within a range of 60 to 100%.

According to a third aspect of the present invention, there is provided a computer readable storage medium that stores a program for execution on a computer, which is used for controlling a liquid processing apparatus, wherein the program, when executed, causes the computer to control the liquid processing apparatus to conduct the liquid processing method according to the first aspect.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view schematically showing the structure of a liquid processing apparatus according to an embodiment of the present invention;

FIG. 2 is a block diagram showing the structure of a control section used in the liquid processing apparatus shown in FIG. 1;

FIGS. 3A, 3B, and 3C are sectional views for explaining steps of a process for etching an organic Low-k film by use of a hard mask;

FIG. 4 is a flow chart showing a sequence for removing the hard mask layer and polymers from the state shown in FIG. 3C;

FIG. 5 is a view for explaining a state of the liquid processing apparatus in the first step;

FIG. 6 is a view for explaining a state of switching from the discard side to the collection side in the second step;

FIGS. 7A and 7B are sectional views for explaining the first step and third step, respectively;

FIG. 8 is a timing chart showing a preferably example of chemical liquid delivery in the first step;

FIG. 9 is a view showing the chemical liquid supply timing and supply flow rate in a preferable method for removing the hard mask layer and polymers; and

FIG. 10 is a view showing the chemical liquid supply flow rate in another preferable method for removing the hard mask layer and polymers.

### DETAILED DESCRIPTION OF THE INVENTION

An embodiment of the present invention will now be described with reference to the accompanying drawings.

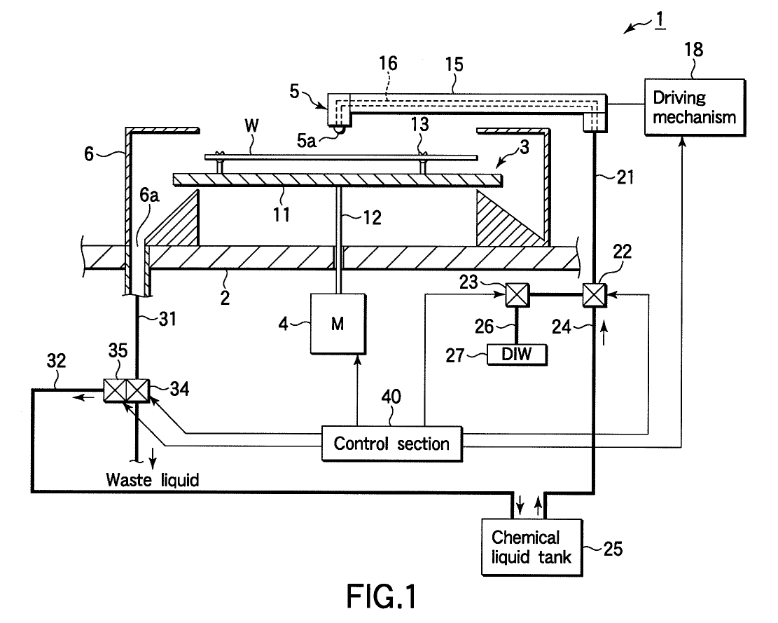

FIG. 1 is a sectional view schematically showing the structure of a liquid processing apparatus according to an embodiment of the present invention. This liquid processing apparatus 1 is designed to perform a process for removing a hard mask (HM) on the surface of a target substrate, such as a semiconductor wafer (which may simply referred to as a wafer), by use of a chemical liquid.

This liquid processing apparatus 1 includes a chamber (not shown) with a base plate 2 serving as the base of the chamber, and a spin chuck 3 disposed inside the chamber. The spin chuck 3 includes a rotary plate 11 and a rotary shaft 12 connected to the center of the rotary plate 11. The rotary plate 11 is provided with holding pins 13 respectively disposed at equidistant three positions near the edge to hold a wafer W. The holding pins 13 are configured to hold the wafer W in a horizontal state slightly separated from the rotary plate 11. Each of the holding pins 13 is rotatable between a holding position for holding the wafer W and a rearward releasing position for cancelling the hold of the wafer W. Further, the rotary plate 11 is provided with support pins (not shown) respectively disposed at equidistant three positions near the edge to support the wafer W when the wafer W is transferred between the transfer arm (not shown) and spin chuck 3. The rotary shaft 12 extends downward through the base plate 2 and is rotatable by a motor 4. When the rotary plate 11 is rotated by the motor 4 through the rotary shaft 12, the wafer W held on the rotary plate 11 is rotated.

A process liquid delivery nozzle 5 is disposed above the spin chuck 3 to deliver process liquids on the surface of the wafer W held on the spin chuck 3, such as a chemical liquid for removing the HM and polymers and purified water used as a rinsing liquid. The process liquid delivery nozzle 5 is attached to the distal end of a nozzle arm 15. The nozzle arm 15 has a process liquid flow passage 16 formed therein and connected to the nozzle hole 5a of the process liquid delivery nozzle 5. The nozzle arm 15 is swingable by a driving mechanism 18. The nozzle arm 15 is swung by the driving mechanism 18, when the process liquid delivery nozzle 5 is moved between a delivery position directly above the center of the wafer W and a waiting position outside the wafer W.

The other end of the process liquid flow passage 16 of the nozzle arm 15 is connected to a process liquid supply line 21. The process liquid supply line 21 is provided with switching valves 22 and 23. A piping line 24 is connected to the process liquid supply line 21 at the switching valve 22. The other end of the piping line 24 is connected to a chemical liquid tank 25 that stores a chemical liquid for removing the HM and polymers. A piping line 26 is connected to the process liquid supply line 21 at the switching valve 23. The other end of the piping line 26 is connected to a DIW supply source 27 for supplying purified water (DIW). By operating the switching valves 22 and 23, the chemical liquid and purified water can be supplied from the chemical liquid tank 25 and DIW supply source 27, through the piping lines 24 and 26, process liquid supply line 21, and process liquid flow passage 16, into the process liquid delivery nozzle 5.

A drain cup 6 is disposed outside the rotary plate 11 to surround the edge of the wafer W held on the rotary plate 11 and to receive drainage of a process liquid scattered from the wafer W. A drain port 6a is formed in the bottom of the drain cup 6 and is connected to a drain line 31 extending downward. A collection line 32 is branched from the drain line 31 on the way to collect the chemical liquid. The collection line 32 is connected to the chemical liquid tank 25, so that the chemical liquid can be collected through the collection line 32 into the chemical liquid tank 25.

The drain line 31 is provided with a switching valve 34 at a position where the collection line 32 is branched. The collection line 32 is provided with a switching valve 35 near the branch point. When the switching valve 34 is opened and the switching valve 35 is closed, drainage is discharged through the drain line 31 into a drain processing facility and is then discarded. On the other hand, when the switching valve 34 is closed and the switching valve 35 is opened, drainage is discharged through the collection line 32 into the chemical liquid tank 25. Accordingly, the switching valves 34 and 35 serve as a switching mechanism for switching between the collection side and discard side.

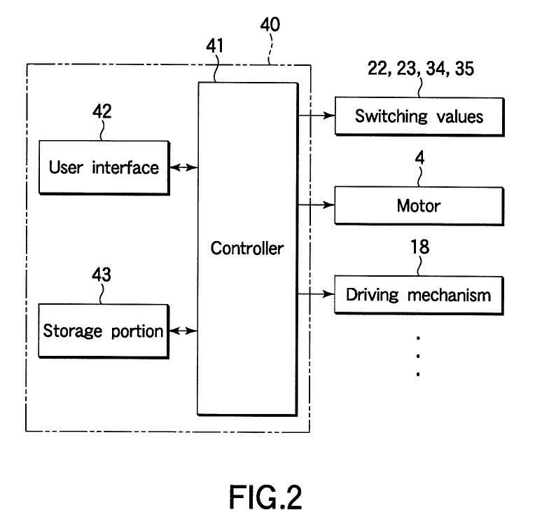

The liquid processing apparatus 1 includes a control section 40. As shown in the block diagram of FIG. 2, the control section 40 includes a controller 41, a user interface 42, and a storage portion 43. The controller 41 comprises a microprocessor (computer), which controls the respective components of the liquid processing apparatus 1, such as the switching valves 22, 23, 34, and 35, motor 4, and driving mechanism 18. The controller 41 is connected to the user interface 42, which includes, e.g., a keyboard and a display, wherein the keyboard is used for an operator to input commands for operating the liquid processing apparatus 1, and the display is used for showing visualized images of the operational status of the liquid processing apparatus 1. Further, the controller 41 is connected to the storage portion 43 that stores process recipes, i.e., control programs for controlling control targets of the respective components of the liquid processing apparatus 1 and programs for the liquid processing apparatus 1 to perform predetermined processes. The process recipes are stored in a storage medium included in the storage portion 43. The storage medium may be formed of a medium of the stationary type, such as a hard disk, or a medium of the portable type, such as a CDROM, DVD, or flash memory. Alternatively, the recipes may be used online while they are transmitted from another apparatus through, e.g., a dedicated line, as needed. A required recipe is retrieved from the storage portion 43 and executed by the controller 41 in accordance with an instruction or the like input through the user interface 42. Consequently, the liquid processing apparatus 1 can perform a predetermined process under the control of the controller 41.

Next, an explanation will be given of a process operation for performing a process for removing a hard mask (HM) on a wafer W in the liquid processing apparatus 1 described above.

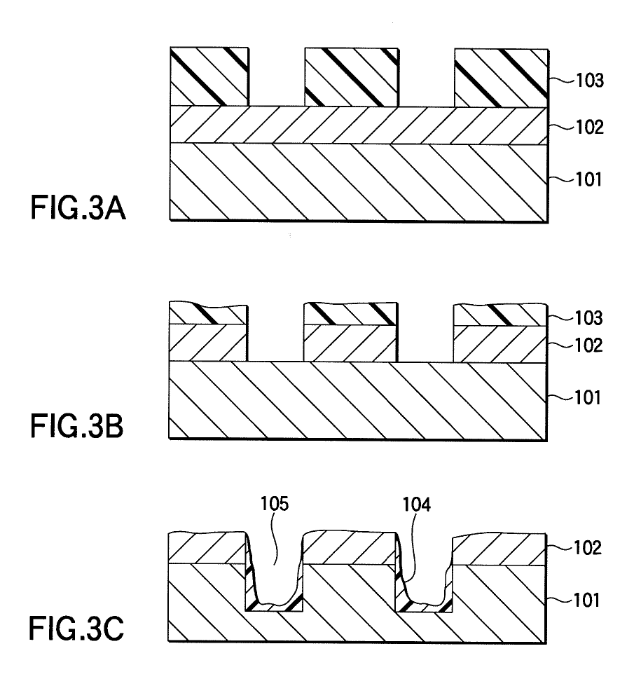

According to this process, as shown in FIG. 3A, where an organic Low-k film 101 is etched, a hard mask (HM) layer 102 is formed on the Low-k film 101, and a photo-resist film 103 is formed on the HM layer 102 and is patterned by a photolithography step in accordance with a predetermined pattern. Then, as shown in FIG. 3B, while the photo-resist film 103 thus patterned is used as a mask, the HM layer 102 is etched, so that the resist pattern is copied on the HM layer 102. Then, as shown in FIG. 3C, while the HM layer 102 is used as a mask, the Low-k film 101 is etched, so that a hole is formed, for example. At this time, polymers 104 are deposited on the inner wall of the hole 105.

According to this embodiment, a chemical liquid process is performed to remove the HM layer 102 and polymers 104 from the state shown in FIG. 3C. The HM layer 102 may be preferably formed of a Ti film and/or TiN film, as generally used. The chemical liquid for removing the HM layer 102 and polymers 104 may be a chemical liquid of this kind generally used, such as a liquid containing hydrogen peroxide solution as a base with a predetermined organic component added thereto.

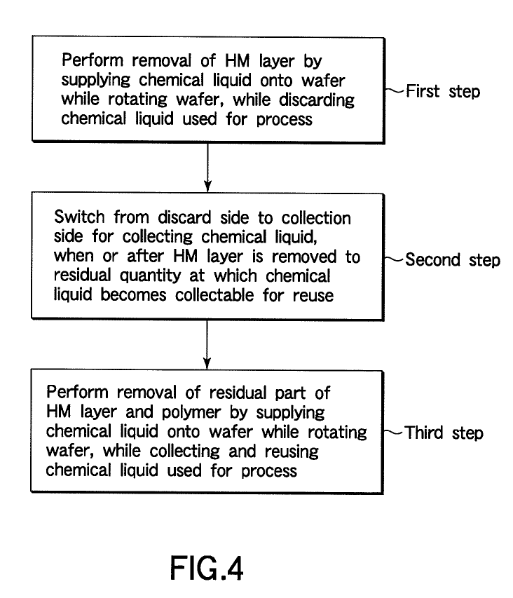

When the HM layer 102 and polymers 104 are removed, the wafer W including the Low-k film 101 and HM layer 102 with the hole 105 formed therein as shown in FIG. 3C is transferred into the liquid processing apparatus. Then, the wafer W is held on the spin chuck 3, and the process is performed in accordance with the flow chart shown in FIG. 4, as described below.

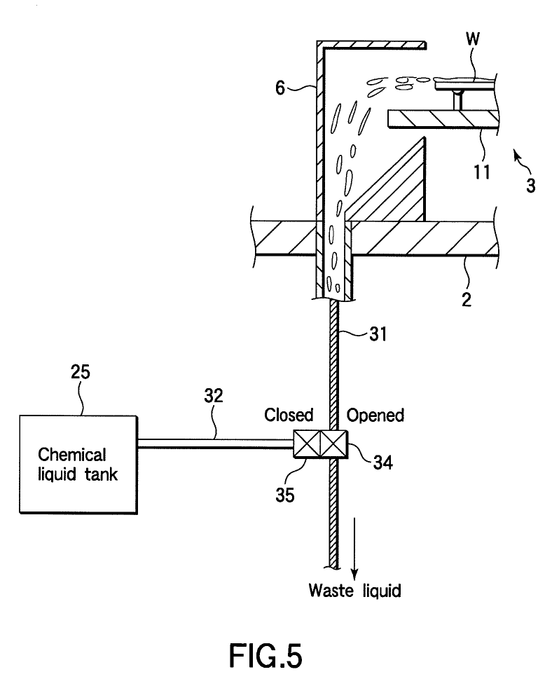

In this state, at first, the first phase liquid process is performed (first step). In this first step, the process liquid supply nozzle 5 is positioned directly above the center of the wafer W. Then, while the wafer W is rotated by the spin chuck 3, a chemical liquid for removing the HM and polymers is delivered from the process liquid supply nozzle 5 onto the surface of the wafer W to perform a process for removing the HM layer 102. At this time, it is necessary to maintain the chemical liquid inside the chemical liquid tank 25 at a temperature of about 50 to 80° C. by a heater (not shown) and to maintain the chemical liquid on the wafer W at a temperature of 30° C. or more. During this first step being thus performed, as shown in FIG. 5, the switching valve 34 is set opened and the switching valve 35 is set closed, so that the chemical liquid thrown off from the wafer W and received by the drain cup 6 is discarded. In this respect, if the chemical liquid is collected from the beginning, the amount of HM collected in the chemical liquid tank 25 becomes very large, and such a chemical liquid is not suitable for reuse. Accordingly, in the first step, the chemical liquid used in the process is discarded.

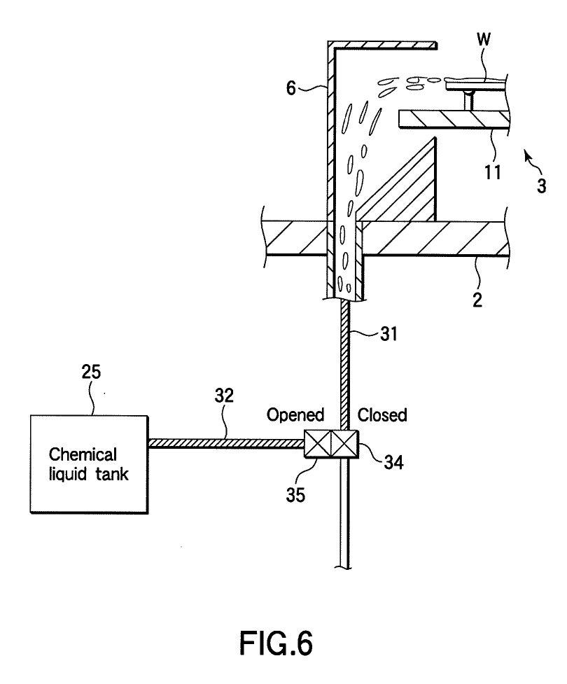

However, with progress of the process for removing the HM layer 102, the residual quantity of the HM layer 102 is decreased. After the elapse of a predetermined time, the residual quantity reaches a level at which the chemical liquid can be reused without a hitch even if the layer 102 is entirely removed by the chemical liquid and collected along with the chemical liquid and contained therein as residues. Accordingly, at an appropriate timing when or after the residual quantity of the HM layer 102 reaches such a level, the switching valve 34 is closed and the switching valve 35 is opened, as shown in FIG. 6, so that switching is performed to a state where the chemical liquid received by the drain cup 6 can be collected through the collection line 32 into the chemical liquid tank 25 (second step). Then, while the chemical liquid thus collected is reused, the second phase liquid process is performed to remove the residual part of the HM layer 102 and polymers 104 (third step). Accordingly, in the second phase liquid process of the third step, the chemical liquid used in the process is collected through the collection line 32 into the chemical liquid tank 25 and recycled and reused.

The switching timing to the chemical liquid collection in the second step may be set at a timing when or after the elapse of a time period, which is obtained in advance for the residual quantity of the HM layer 102 to reach a level at which the chemical liquid becomes reusable by recycle even if the layer 102 is entirely removed by the chemical liquid and contained therein as residues. It has been confirmed that, where the removal ratio of the HM layer 102 is 60% or more, such as 80%, the chemical liquid can be reused without a hitch by recycle even if the residual HM layer 102 is collected along with the chemical liquid. Accordingly, a time period may be determined in advance for the HM layer 102 to be removed by a predetermined ratio within a range of 60 to 100%, such as 80%, with reference to the thickness of the HM layer 102 and the etching rate, and the switching to the chemical liquid collection is performed at a timing when or after the elapse of the time period. It should be noted that, as regards etching of the HM layer 102, the etching rate fluctuates to some extent depending on portions, and so the HM layer 102 may be slightly left even after the elapse of the time period for 100% removal.

This switching control is executed such that the control section 40 is preset to have a switching timing determined as described, so as to transmit instructions therefrom to the switching valves 34 and 35 at the timing.

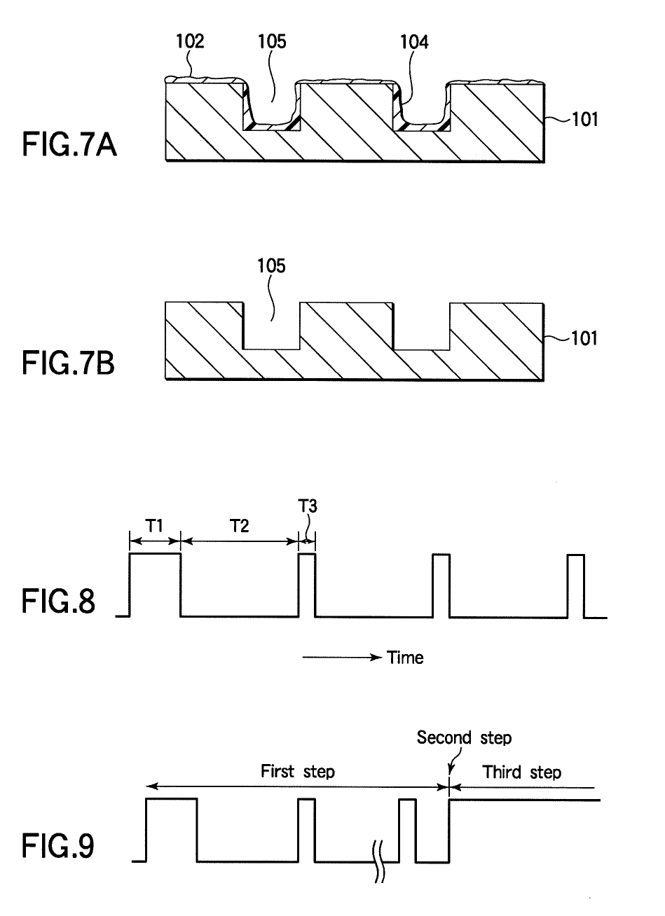

In general, the first step is performed until the residual part of the HM layer 102 becomes small, as shown in FIG. 7A. However, the polymers 104 is essentially still left at the end of the first step because their resistance to removal is higher. In this respect, the first step may be performed until the HM layer 102 is entirely removed. Then, the third step is performed such that the residual part of the HM layer 102 and polymers 104 are removed, or the polymers 104 are removed if the HM layer 102 has already been entirely removed. Consequently, as shown in FIG. 7B, only the organic Low-k film 101 is left in an etched state.

In order to improve the collection ratio of the chemical liquid, the chemical liquid consumption should be set as small as possible in the first step of discarding the chemical liquid. In light of this, the first step is preferably arranged to comprise intermittently supplying the chemical liquid while rotating the wafer W. For example, as shown in FIG. 8, while the wafer W is rotated at a low speed, a liquid film is first formed by supplying the chemical liquid for a time period of T1 shown in FIG. 8, which is about 1 to 10 seconds, such as 5 seconds. Then, while the wafer W is rotated at a low speed, a chemical liquid stop period of T2 and a chemical liquid supply period of T3 are alternately repeated. The chemical liquid stop period of T2 is about 10 to 30 seconds, and preferably 10 to 15 seconds. The chemical liquid supply period of T3 is about 1 to 5 seconds, and preferably about 1 second. At this time, the timings of supplying and stopping the chemical liquid need to be preset so that the surface of the wafer W is kept wet with the chemical liquid. Where the surface of the wafer W is wet with the chemical liquid, the reaction of the chemical liquid with the HM components can make progress. If the surface of the wafer W is dried, problems arise such that particles are generated and it takes time to subsequently form a liquid film on the surface of the wafer W. Further, if a period of not supplying the chemical liquid is too long, the temperature of the chemical liquid on the wafer W becomes lower and decreases the reaction rate. Accordingly, the length of the chemical liquid stop period should be determined in light of the issues described above. The operations of supplying and stopping the chemical liquid can be realized by opening and closing the switching valve 22 in accordance with instructions from the controller 41. The rotational speed of the wafer W used at this time is preferably set to be 50 to 300 rpm. If the speed is higher than 300 rpm, the chemical liquid is scattered in a short time, and so the effect of decreasing the chemical liquid consumption is deteriorated. If the speed is lower than 50 rpm, the chemical liquid is left in a cooled state in a large amount on the wafer W. In this case, the temperature of the wafer W cannot be raised by intermittent delivery of the chemical liquid, and so the HM removal reaction becomes slower.

As described above, where the chemical liquid is intermittently delivered, the chemical liquid consumption can be made far lower, such as 1/10 or less of the case of the chemical liquid being continuously delivered, so that the chemical liquid collection ratio is improved to a large extent. Further, even if such an intermittent process is performed, the intervals of chemical liquid delivery can be suitably preset, so that the chemical liquid temperature is prevented from being lowered and thereby maintain the processing rate, as compared to the case of the chemical liquid being continuously delivered.

In the third step, removal of the polymers 104 is mainly performed as described above, while the chemical liquid is collected for reuse, and so the chemical liquid consumption does not have to be decreased. Further, the polymers are very strongly adhered to the underlying layer, and its removal requires a higher temperature than the HM removal. However, the intermittent delivery of the chemical liquid described above cannot ensure the temperature of the chemical liquid necessary for the reaction. Accordingly, the third step is preferably arranged to perform the process while continuously delivering the chemical liquid. The rotational speed of the wafer W used at this time is preferably set to be 200 to 500 rpm.

In light of the issues described above, the first to third steps are preferably performed as shown in FIG. 9 to improve the collection ratio of the chemical liquid. Specifically, the first step is performed while the chemical liquid is intermittently supplied. Then, the second step is performed to switch from the discard side to the collection side. Then, the third step is performed while the chemical liquid is continuously supplied.

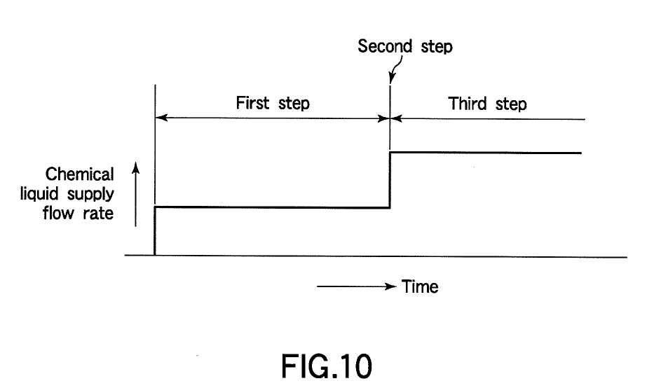

Alternatively, in order to decrease the chemical liquid consumption in the first step and to improve the collection ratio of the chemical liquid, the first to third steps may be performed as shown in FIG. 10. Specifically, both of the first and third steps are performed while the wafer W is rotated and the chemical liquid is continuously supplied. However, the chemical liquid supply flow rate used in the first step is set smaller than the chemical liquid supply flow rate used in the third step. This is so, because the third step for removing the polymers 104 requires a higher temperature of the chemical liquid and so requires the chemical liquid in a larger flow rate. The first step can be performed with a lower temperature of the chemical liquid than that of the third step and so can accept a lower chemical liquid supply flow rate than that of the third step.

After the HM layer 102 and polymers 104 are removed and the Low-k film 101 on the wafer W is made into the state shown in FIG. 7B, a rinsing process is performed on the wafer W, as follows. Specifically, while the wafer W is rotated at a rotational speed of about 100 to 1,000 rpm, the switching valve 22 is closed and the switching valve 23 is opened, so that purified water used as a rinsing liquid is supplied from the purified water supply source 27 through the process liquid supply nozzle 5 onto the wafer W. At this time, the switching valve 35 is set closed and the switching valve 34 is set opened, so that the rinsing liquid thrown off form the wafer W is discarded.

After the rinsing process is performed, if necessary, a drying medium, such as IPA (isopropyl alcohol) is supplied from a drying medium supply mechanism (not shown) onto the wafer W to promote drying of the wafer W, and then the wafer W is rotated at a high speed to perform throwing-off and drying.

The entire process for one wafer is completed with the operations described above.

As described above, according to this embodiment, the first step is arranged to perform removal of the hard mask layer 102 by supplying the chemical liquid onto the wafer W while rotating the wafer W and to discard the chemical liquid used in the process. Then, the second step is arranged to switch from the discard side to the collection side to collect and recycle the chemical liquid used in the process when the residual quantity of the HM layer becomes small enough to reuse the chemical liquid. Then, with this switched state, the third step is arranged to remove the residual part of the hard mask layer 102 and polymers 104, or the polymers 104, while collecting and recycling the chemical liquid. Consequently, the chemical liquid used in the process, which is conventionally discarded, is reliably reused.

Further, the first step that discards the chemical liquid is arranged to comprise intermittently supplying the chemical liquid onto the wafer W while rotating the wafer W, but keeping the surface of the wafer W wet with the chemical liquid during the periods of not supplying the chemical liquid between the periods of supplying the chemical liquid. Consequently, the chemical liquid consumption in the first step can be decreased to make the discarded quantity of chemical liquid as small as possible and to improve the collection ratio of the chemical liquid to a large extent. Alternatively, the chemical liquid supply flow rate used in the first step may be set smaller than the chemical liquid supply flow rate used in the third step. Consequently, the chemical liquid consumption in the first step can be also decreased to make the discarded quantity of chemical liquid as small as possible and to improve the collection ratio of the chemical liquid to a large extent.

According to the embodiment of the present invention, where a hard mask layer is removed by supplying a chemical liquid onto a substrate while rotating the substrate, the chemical liquid used in the process is first discarded. Then, when the process makes progress and the residual quantity of the hard mask layer reaches a level at which the chemical liquid used in the process becomes collectable for reuse, switching is performed to collect and reuse the chemical liquid used in the process that has been discarded, and the residual part of the hard mask layer and polymers, or the polymers, are removed by the chemical liquid. Consequently, the chemical liquid used in the process, which is conventionally discarded, is reliably reused.

Further, the first step that discards the chemical liquid is arranged to comprise intermittently supplying the chemical liquid onto the substrate while rotating the substrate, but keeping the surface of the substrate wet with the chemical liquid during the periods of not supplying the chemical liquid between the periods of supplying the chemical liquid. Alternatively, the chemical liquid supply flow rate used in this process is set smaller than the chemical liquid supply flow rate used in the polymer removal. Consequently, the chemical liquid consumption in the first step can be decreased to make the discarded quantity of chemical liquid as small as possible and to improve the collection ratio of the chemical liquid to a large extent.

The present invention is not limited to the embodiment described above, and it may be modified in various manners. For example, the embodiment described above is exemplified by a case for removing a hard mask and polymers left on an organic Low-k film processed as an etching target film, but the underlying etching target film is not limited to a specific one. Further, in the embodiment described above, the target substrate is exemplified by a semiconductor wafer, but the present invention may be applied to another substrate, such as a substrate for flat panel display devices (FPD), a representative of which is a glass substrate for liquid crystal display devices (LCD).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid processing method for performing a liquid process, after an etching target film formed on a surface of a substrate is etched through a hard mask layer used as an etching mask and having a predetermined pattern formed therein, the liquid process being used for removing the hard mask layer and a polymer deposited due to etching, the method comprising:
a first step of performing removal of the hard mask layer by supplying a chemical liquid onto the substrate while rotating the substrate, while discarding the chemical liquid used in the liquid process by use of a discard side;
a second step of switching from the discard side to a collection side for collecting the chemical liquid used in the liquid process and recycling the chemical liquid in the liquid process, when the hard mask layer is removed by the first step to a residual quantity at which the chemical liquid used in the liquid process becomes collectable for reuse; and
a third step of then performing removal of a residual part of the hard mask layer and the polymer, or the polymer, by supplying the chemical liquid onto the substrate while rotating the substrate, while collecting and reusing the chemical liquid used in the liquid process by use of the collection side.

2. The liquid processing method according to claim 1, wherein the first step comprises intermittently supplying the chemical liquid onto the substrate while rotating the substrate, but keeping the surface of the substrate wet with the chemical liquid during chemical liquid stop periods of not supplying the chemical liquid between chemical liquid supply periods of supplying the chemical liquid, and the third step comprises continuously supplying the chemical liquid onto the substrate while rotating the substrate.

3. The liquid processing method according to claim 2, wherein the first step comprises first supplying the chemical liquid to form a liquid film on the substrate, and then alternately repeating the chemical liquid stop periods and the chemical liquid supply periods.

4. The liquid processing method according to claim 3, wherein the first step is arranged such that each of the chemical liquid stop periods falls within a range of 10 to 30 seconds and each of the chemical liquid supply periods falls within a range of 1 to 5 seconds.

5. The liquid processing method according to claim 2, wherein the first step is arranged to rotate the substrate at a rotational speed of 50 to 300 rpm.

6. The liquid processing method according to claim 1, wherein each of the first step and the third step comprises continuously supplying the chemical liquid onto the substrate while rotating the substrate, such that a chemical liquid supply flow rate used in the first step is set smaller than a chemical liquid supply flow rate used in the third step.

7. The liquid processing method according to claim 1, wherein the second step is arranged to switch from the discard side to the collection side at a timing when or after elapse of a time period obtained in advance for the hard mask layer to be removed by a predetermined ratio within a range of 60 to 100%.

8. A liquid processing apparatus for performing a liquid process, after an etching target film formed on a surface of a substrate is etched through a hard mask layer used as an etching mask and having a predetermined pattern formed therein, the liquid process being used for removing the hard mask layer and a polymer deposited due to etching, the apparatus comprising:
a holding mechanism configured to rotate along with the substrate held thereon;
a rotation mechanism configured to rotate the holding mechanism;
a chemical liquid supply mechanism configured to supply a chemical liquid onto the surface of the substrate held on the holding mechanism;
a drain cup configured to surround an edge of the substrate held on the holding mechanism and to receive the chemical liquid used in the liquid process and thrown off from the substrate;
a drain line configured to discharge the chemical liquid used in the liquid process and received by the drain cup;
a collecting mechanism configured to collect for reuse the chemical liquid used in the liquid process and discharged from the drain cup;
a switching mechanism configured to switch between a discard side for discarding the chemical liquid used in the liquid process through the drain line and a collection side for collecting the chemical liquid used in the liquid process by the collecting mechanism; and
a control section configured to control the rotation mechanism, the chemical liquid supply mechanism, and the switching mechanism,
wherein the control section is preset to execute
a first step of performing removal of the hard mask layer by supplying the chemical liquid from the chemical liquid supply mechanism onto the substrate while rotating the substrate by the rotation mechanism, while discarding the chemical liquid used in the liquid process by use of the discard side set by the switching mechanism,
a second step of switching from the discard side to the collection side by the switching mechanism when the hard mask layer is removed by the first step to a residual quantity at which the chemical liquid used in the liquid process becomes collectable for reuse; and
a third step of then performing removal of a residual part of the hard mask layer and the polymer, or the polymer, by supplying the chemical liquid from the chemical liquid supply mechanism onto the substrate while rotating the substrate by the rotation mechanism, while collecting and reusing the chemical liquid used in the liquid process by use of the collection side set by the switching mechanism.

9. The liquid processing apparatus according to claim 8, wherein the control section is preset to execute
the first step to comprise intermittently supplying the chemical liquid from the chemical liquid supply mechanism onto the substrate while rotating the substrate by the rotation mechanism, but keeping the surface of the substrate wet with the chemical liquid during chemical liquid stop periods of not supplying the chemical liquid between chemical liquid supply periods of supplying the chemical liquid, and
the third step to comprise continuously supplying the chemical liquid onto the substrate while rotating the substrate by the rotation mechanism.

10. The liquid processing apparatus according to claim 9, wherein the control section is preset to execute the first step to comprise first supplying the chemical liquid to form a liquid film on the substrate, and then alternately repeating the chemical liquid stop periods and the chemical liquid supply periods.

11. The liquid processing apparatus according to claim 8, wherein the control section is preset to execute each of the first step and the third step to comprise continuously supplying the chemical liquid onto the substrate while rotating the substrate, such that a chemical liquid supply flow rate used in the first step is set smaller than a chemical liquid supply flow rate used in the third step.

12. The liquid processing apparatus according to claim 8, wherein the control section is preset to execute the second step to switch from the discard side to the collection side by the switching mechanism at a timing when or after elapse of a time period obtained in advance for the hard mask layer to be removed by a predetermined ratio within a range of 60 to 100%.

13. A computer readable storage medium that stores a program for execution on a computer, which is used for controlling a liquid processing apparatus, wherein the program, when executed, causes the computer to control the liquid processing apparatus to conduct a liquid processing method for performing a liquid process, after an etching target film formed on a surface of a substrate is etched through a hard mask layer used as an etching mask and having a predetermined pattern formed therein, the liquid process being used for removing the hard mask layer and a polymer deposited due to etching, the method comprising:
a first step of performing removal of the hard mask layer by supplying a chemical liquid onto the substrate while rotating the substrate, while discarding the chemical liquid used in the liquid process by use of a discard side;
a second step of switching from the discard side to a collection side for collecting the chemical liquid used in the liquid process and recycling the chemical liquid in the liquid process, when the hard mask layer is removed by the first step to a residual quantity at which the chemical liquid used in the liquid process becomes collectable for reuse; and
a third step of then performing removal of a residual part of the hard mask layer and the polymer, or the polymer, by supplying the chemical liquid onto the substrate while rotating the substrate, while collecting and reusing the chemical liquid used in the liquid process by use of the collection side.
